(19) United States
(12) Patent Application Publication
(10) Pub. No.: US 2003/0072311 A1
(43) Pub. Date: Apr. 17, 2003

(54) System for transmission of data

(76) Inventor: Johann Pfeiffer, Wien (AT)

Correspondence Address: HENRY M FEIEREISEN, 350 FIFTH AVENUE, SUITE 3220, NEW YORK, NY, 10118, US

(21) Appl. No.: 10/303,315

(22) Filed: Nov. 25, 2002

Related U.S. Application Data
(63) Continuation of application No. PCT/AT01/00167, filed on May 25, 2001.

(30) Foreign Application Priority Data
May 26, 2000 (AT) A 926/2000

(51) Int. Cl. H04L 12/28

(52) U.S. Cl. 370/395.1; 370/395.43

(57) ABSTRACT

A data transmission system is described between a central location, connected to a data cell transmission network, for example, an ATM (Asynchronous Transfer Mode) network and a peripheral user-network termination unit, connected to the central location by means of a plurality of digital transmission lines. A lower data transmission rate may be transmitted over each of the digital transmission lines than the data transmission rate of the transmission network, whereby an inverse multiplexing device is provided in each of the central location and in the peripheral user-network termination unit. The inverse multiplexing device in the peripheral user-network termination unit may be assembled from a first and, optionally, one or several further multiplexing modules, whereby each multiplexing module is connected to one of the digital transmission lines. At least one unit is provided for the control and synchronization of partial data cell streams.

### CROSS-REFERENCES TO RELATED APPLICATIONS

This application is a continuation of prior filed copending PCT International application no. PCT/AT01/00167, filed May 25, 2001, which was not published in English and which designated the United States and on which priority is claimed under 35 U.S.C. §120, the disclosure of which is hereby incorporated by reference.

This application claims the priority of Austrian Patent Application, Serial No. A 926/2000, filed May 26, 2000, pursuant to 35 U.S.C. 119(a)-(d), the disclosure of which is incorporated herein by reference.

### BACKGROUND OF THE INVENTION

The present invention relates to a system for transmission of data between a central location, connected to a data cell transmission network, and a peripheral user-network termination unit, connected to the central location by means of a plurality of digital transmission lines which transmit at a smaller data transmission rate than the data transmission rate of the peripheral user-network termination unit, whereby an inverse multiplexing device is provided in each of the central location and the peripheral user-network connection unit for splitting the data cell stream, to be transmitted via the transmission lines, into several partial data cell streams, and for combining the partial data cell streams transmitted via the transmission lines.

Transfer and switching of data packets for sending digital information in communication networks is widely known, whereby a particular type of this transmission mode is known under the designation ATM (Asynchronous Transfer Mode). This transmission mode involves the transfer of data, split in cells and combined to data packets, at a constant data rate (constant bit rate CBR) or at variable data rate (unspecified bit rate UBR, and variable bit rate VBR), whereby data cells can be received and transmitted at the subscriber's end via network termination units. Data to be transferred are subdivided in hubs into defined packets, equipped with an address and further auxiliary information, such as e.g. fail-safe codes, and transmitted in packets to the next hub regardless of origin or targeted location.

Transmission connections used in such a transmission network include copper lines as well as glass fiber lines to enable very high data rates. The connection of many private subscribers to these high-speed networks is oftentimes realized by existing two-wire lines that use transmission services such as e.g. xDSL, HDSL (High Speed Digital Subscriber Line), ADSL (Asymmetric Digital Subscriber Line), VDSL (Very High Speed Digital Subscriber Line), or other like for transmission of data rates of, e.g. 2 MBit/s. When higher transmission speed are demanded, it has been proposed to combine several such parallel transmission channels and to split the information to be transmitted via inverse multiplexing devices (IMA, for Inverse Multiplexing for ATM) upon the respective lines for transmission to the subscriber. Since the information to be transmitted is already divided in cells, the distribution of the data onto the lines and combination of the transmitted data to a data stream can be realized in a simple manner.

Conventional inverse multiplexing devices have the drawback of a limited flexibility as far as their use on the subscriber end is concerned. The subscriber may either be satisfied with a relatively low data rate of a single two-wire line, or utilizes an IMA transmission which is offered by a network operator and combines at least two two-wire lines with a respectively high overall data rate. In case, the demands of the subscriber range between one and four lines, the IMA approach results oftentimes in an overdimensioned configuration and incurs high costs at slight work-load because parts of the user-network termination unit remains idle. Hereby, the stated number of lines is to be understood as an example only.

FIGS. 1 and 2 depict block diagrams of a conventional data transmission system between a central location 20, connected to an ATM-network 50, and a peripheral user-network termination unit 4, which is connected to the central location 20 via several digital transmission lines 15. Hereby, bidirectional data transmission is presumed. The data streams within the ATM network 50 are divided in cells respectively formed by a header and a useful data field. Cells of this type are transmitted asynchronously. The identification contained in the header is evaluated for transfer of the cells between successive transmission sections, and is used to determine which ATM connection is involved at the respective point in time.

Additional digital lines 11, 13, 14 connect the central location 20 to further network termination units 1, 2, 3, whereby the central location 20 is provided with respective line cards 5, 6, 7 which respectively represent a digital transmission channel. The transmission process applied for the data lines may vary and may include, e.g., . xDSL, HDSL,,ADSL, VDS, SDSL, that allow a data rate of e.g. 2 MBit/s upon the digital lines 5, 6, 7. The digital lines 5, 6, 7 may be implemented, e.g., as two-wire lines which already exist as lines between the central location 20, e.g. a dialing station, and the subscribers, and thus do not allow higher transmission speeds.

A higher data throughput is realized via the network termination unit 4 by connecting the digital lines 15 to a line card 8 which includes an inverse multiplexing device 10, as shown in FIG. 2, for dividing the ATM data cells, incoming from the ATM-network via a connection line 16, onto the lines 15 via which the partial data cell streams are transmitted parallel and combined again in a further inverse multiplexing device of the peripheral user-network termination unit 4. Hereby, four 2 MBit/s lines 15 enable overall an 8 MBit/s transmission rate at the subscriber's end. The partial data cell streams, combined at the subscriber's end, are provided on a line 17 as ATM data cell stream. As a result of the subdivision of the ATM data stream in cells, the distribution of these cells onto the individual lines 15 can be carried out with the information blocks provided already in the cells, so that the appropriate reunion on the receiver's end is respectively simple.

During transmission in opposite direction, the ATM data cell stream, incoming from the subscriber, is split in the inverse multiplexing device of the user-network termination unit 4 into partial data cell streams which are transmitted via the lines 15 and combined again in the inverse multiplexing device 10 for transmission via the line 16 into the ATM network 50. In the event, one of the lines 15 fails and becomes unavailable for data transmission, transmission can then be realized only via the remaining three lines 15 so that only 6 MBit/s are available instead of the possible 8 MBit/s.

The problem of these conventional inverse multiplexing devices is their limited flexibility because not every subscriber necessarily exploits the availability of 8 MBit/s, even though the costs for such a unit and for the provision of the transmission lines 15 are fairly high. Demands in the magnitude of, for example, 4 or 6 MBit/s, mean that one or two of the transmission lines 15 are on used but have still to be made available so that the overall efficiency on the side of the central location 20 is reduced.

It would therefore be desirable and advantageous to provide an improved data transmission system and method, which obviate prior art shortcomings and which can be suited to the subscriber's needs at hand.

### SUMMARY OF THE INVENTION

According to one aspect of the present invention, a data transmission system, includes a data cell transmission network having a data transmission rate, a central location connected to the data cell transmission network, a peripheral user-network termination unit, a plurality of digital transmission lines connecting the peripheral user-network termination unit to the central location for transmitting a data cell stream at a data transmission rate which is smaller than the data transmission rate of the data cell transmission network, wherein the central location and the peripheral user-network termination unit have each an inverse multiplexing device for dividing the data cell stream to be transmitted via the transmission lines into a plurality of partial data cell streams and for uniting the plurality of partial data cell streams transmitted via the transmission lines, wherein the inverse multiplexing device of the peripheral user-network termination unit includes a first multiplexing module and at least one second multiplexing module, with the first and second multiplexing modules associated to the transmission lines in one-to-one correspondence, and further including at least one unit for control and synchronization of the partial data cell streams by dividing the data cell stream to be transmitted in accordance to the number of the first and second multiplexing modules and the transmission rate thereof and directing partial data cell streams to the first and second multiplexing modules or adding partial data cell stream coming from the first and second multiplexing modules to the transmitted data cell stream.

The present invention resolves prior art problems by configuring the inverse multiplexing device of the peripheral user-network termination unit of modular configuration so that the inverse multiplexing device can be best suited to the individual needs of the subscriber by adding one or more multiplexing modules to the first multiplexing module according to need. The multiplexing modules are connected to the transmission lines, connected to the central location, in one-to-one correspondence so that each multiplexing module transmits and receives the data rate established for this transmission line. When the subscriber demands a greater transmission rate, the user-network termination unit can be retrofitted by one or more multiplexing modules.

According to another feature of the present invention, the data cell transmission network may be an ATM (Asynchronous Transfer Mode) network. As a consequence of its high coverage degree, the ATM transfer technology is suitable for many applications.

According to another feature of the present invention, all multiplexing modules may have a same data transmission rate. In this way, production and storage for each module is cost-efficient, and each subscriber can increase the transmission rate of the inverse multiplexing device at any time through installation of a further module of a same kind.

According to another feature of the present invention, each of the multiplexing modules may include a transmission interface for connection to one of the digital transmission lines, an input/output interface and a transfer interface, wherein the multiplexing modules are so connectable in series that the transfer interface of one of the multiplexing modules is connected to the input/output interface of the next following multiplexing module, wherein the unit for control and synchronization of the partial data cell streams taps a partial data cell stream from the data cell stream to be transmitted for transmission to one of the multiplexing modules and taps a further partial data cell stream from the remainder of the data cell stream for transmitting to the following multiplexing modules. Through simple connection of the multiplexing modules via the input/output interfaces and the transfer interfaces, the multiplexing modules can be rapidly assembled and can easily be produced.

During transmission, a first transmission channel, e.g. a 2 MBit/s channel is extracted from the outgoing data cell stream in the first multiplexing module and transmitted to the associated digital transmission line. The remaining data stream is directed to the second multiplexing module in which a second transmission channel, e.g. a 2 MBit/s channel is extracted for transfer to the respectively assigned digital transmission line for transmission. The remaining data stream is divided in a same manner onto the subsequent multiplexing modules by tapping until no data remains. Therefore, the number of multiplexing modules can be so selected that the required total data cell stream is reached. In the opposite transmission direction, the received data cell streams are combined by the individual multiplexing modules to again produce a complete data cell stream.

According to another feature of the present invention, the first multiplexing module may include the unit for control and synchronization of the partial data cell streams. In this way, the first multiplexing module represents a base unit which can be expanded through the use of further multiplexing modules.

According to another feature of the present invention, the input/output interface and the transfer interface may have a transmission rate of 25.6 MBit/s.

According to another aspect of the present invention, a method of transmitting a data cell stream between a central location, connected to a data cell transmission network, and a peripheral user-network termination unit, connected to the central location, via a plurality of digital transmission lines at a data transmission rate which is smaller than a data transmission rate of the transmission network, includes the steps of dividing the data cell stream into several partial data cell streams in an inverse multiplexing device of one of the central location and the user-network termination unit, transmitting the partial data cell stream to an inverse multiplexing device of the other one of the central location and the user-network termination unit via the digital transmission lines, with the inverse multiplexing device of the peripheral user-network termination unit including a first multiplexing module and at least one second multiplexing module which are associated to the transmission lines in one-to-one correspondence, whereby the data cell stream to be transmitted is divided according to the number of multiplexing modules and their transmission rate into partial data cell streams, wherein the partial data cell streams are fed to the multiplexing modules or the partial data cell streams coming from the multiplexing modules are added to the data cell stream being transmitted, and combining the partial data cell streams in the inverse multiplexing device of the other one of the central location and user-network termination unit.

In this way, the transmission rate as desired by the subscriber can be realized through installation of a respective number of multiplexing modules to divide the data cell stream to be transmitted accordingly.

As the data cell transmission network may be implemented by an ATM (Asynchronous Transfer Mode) network, the method according to the invention can be reliably used for a great many of existing networks.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a block diagram of a conventional data transmission system;

FIG. 2 is a block diagram of a detailed of the data transmission system of FIG. 1; and

FIG. 3 is a block diagram of a data transmission system embodying the subject matter of the present invention.

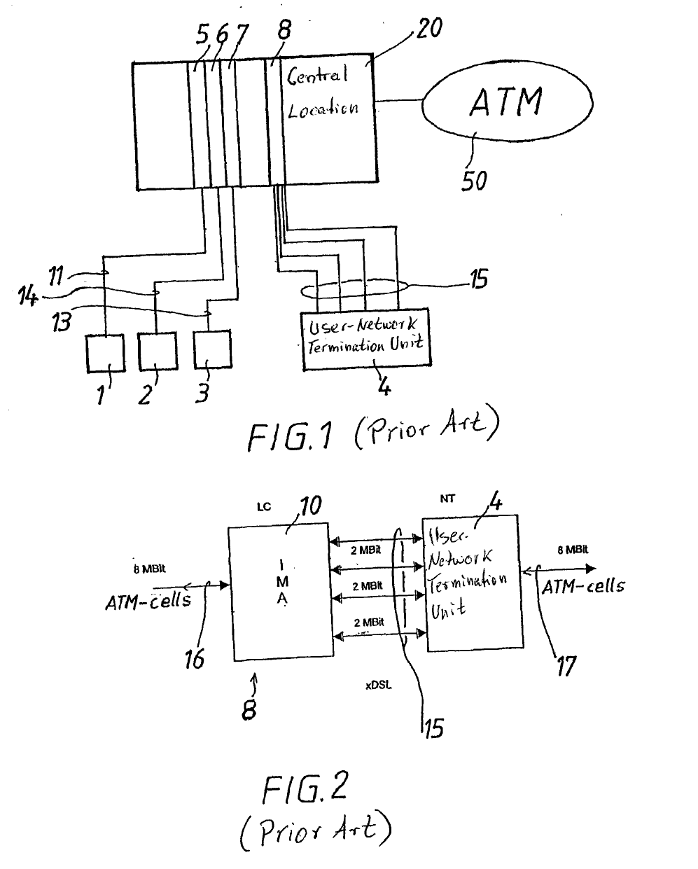

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. The present invention is useful for application in existing data cell transmission networks in which data streams are subdivided into individually identifiable cells.

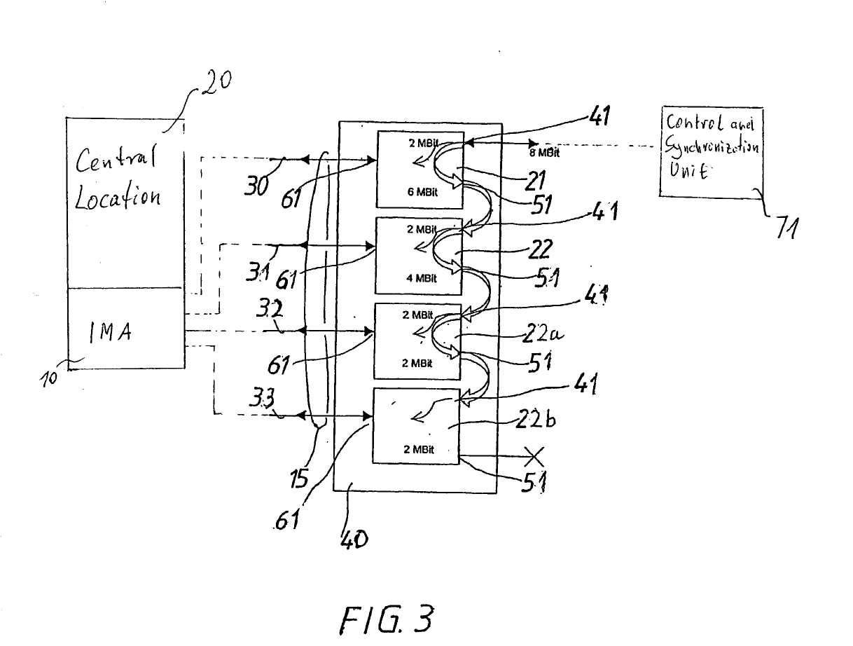

Turning now to the drawing, and in particular to FIG. 3, there is shown a block diagram of a data transmission system embodying the subject matter of the present invention. In accordance with the present invention, the data transmission system includes a peripheral user-network termination unit 40 which has a modular configuration and is provided with an inverse multiplexing device composed of a first or basic multiplexing module 21 and, optionally, one or more of further multiplexing modules 22. In the non-limiting example of FIG. 3, the inverse multiplexing device has a total of four multiplexing modules, that is the basic multiplexing module 21, and three additional multiplexing modules 22, 22a, 22b for transmission of a total of 8 MBit/s. Even though reference numerals 21, 22 have been assigned here to the first and second multiplexing modules, the multiplexing modules may, of course, be of identical configuration.

The multiplexing modules 21, 22, 22a, 22b have each a transmission interface 61 for connection to respective digital transmission lines 30, 31, 32, 33 which are dimensioned, e.g., for a transmission rate of 2 MBit/s. Thus, the multiplexing modules 21, 22, 22a, 22b are assigned to the digital transmission lines 30, 31, 32, 33 in one-to-one correspondence, and have a same data transmission rate so that identical multiplexing modules 21, 22, 22a, 22b can be combined. Each multiplexing module 21, 22, 22a, 22b, 23, 24 further includes an input-output interface 41 and a transfer interface 51, whereby the interfaces 41, 51 are each formed by 25 MBit/s interfaces. In this way, the multiplexing modules 21, 22, 22a, 22b are connectable in series. The subscriber may use, depending on need, one, two, three or four digital transmission lines 30, 31, 32, 33, whereby a respective number of multiplexing modules 21, 22, 22a, 22b can be combined by connecting the input-output interface 41 of each multiplexing module with the transfer interface 51 of the respectively following multiplexing module.

In order to realize an appropriate division of the data stream and an appropriate reunion of the individual data cells or partial data cell streams, the data transmission system according to the invention includes a unit 71 for control and synchronization of the partial data cell streams by which the data cell stream to be transmitted is split in accordance with a respective number of multiplexing modules 21, 22, 22a, 22b, and the split partial data cell streams are delivered to the multiplexing modules 21, 22, 22a, 22b or, vice versa, the partial data cell streams, incoming from one of the multiplexing modules 21, 22, 22a, 22b, are added to the transmitted data cell stream. Currently preferred is the incorporation of the unit 71 for control and synchronization of partial data cell streams within the first multiplex unit 21, as shown schematically by way of example in FIG. 3. The present invention should, however, not be limited to this construction.

FIG. 3 shows, by way of example, the arrangement of four multiplexing modules 21, 22, 22a, 22b, connected in series, with the unit 71 for control and synchronization of the partial data cell streams feeding the data cell streams to be transmitted to the multiplexing modules 21, 22, 22a, 22b by tapping from this data cell stream a respective partial data cell stream for transfer to one of the multiplexing modules 21, 22, 22a, 22b, as well as tapping a further partial data cell stream from the remaining data cell stream for transfer to the respectively following multiplexing module. In opposite transmission direction, the respective partial data cell stream from one of the multiplexing modules 21, 22, 22a, 22b is added to the data cell stream.

The data cell stream to be transmitted, which in the exemplified embodiments shown here is transmitted at 8 MBit/s, is directed via the input-output interface 41 into the first multiplex unit 21. A 2 MBit/s partial cell data stream is extracted and transmitted via the transmission lines 30, 31, 32, 33 to the inverse multiplexing device in the central location 20. The remaining data cell stream of 6 MBit/s is guided via the transfer interface 51 to the input-output interface 41 of the following multiplexing module 22 from which again a 2 MBit/s partial cell data stream is transmitted via the transmission line 31. The remaining 4 MBit/s data stream is fed to the multiplexing module 22a for transmission of a 2 MBit/s partial cell data stream via the transmission line 32. This process is repeated until only a 2 MBit/s partial data cell stream remains for the last multiplexing module, here multiplexing module 22b, for transmission of the 2 MBit/s partial cell data stream via the transmission line 33. The transfer interface 54 of the multiplexing module 22b remains unused here.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A data transmission system, comprising:
a data cell transmission network having a data transmission rate;
a central location connected to the data cell transmission network;
a peripheral user-network termination unit;
a plurality of digital transmission lines connecting the peripheral user-network termination unit to the central location for transmitting a data cell stream at a data transmission rate which is smaller than the data transmission rate of the data cell transmission network, wherein the central location and the peripheral user-network termination unit have each an inverse multiplexing device for dividing the data cell stream to be transmitted via the transmission lines into a plurality of partial data cell streams and for uniting the plurality of partial data cell streams transmitted via the transmission lines, wherein the inverse multiplexing device of the peripheral user-network termination unit includes a first multiplexing module and at least one second multiplexing module, with the first and second modules associated to the transmission lines in one-to-one correspondence; and
at least one unit for control and synchronization of the partial data cell streams by dividing the data cell stream to be transmitted in accordance to the number of the first and second multiplexing modules and the transmission rate thereof and directing partial data cell streams to the first and second multiplexing modules or adding partial data cell stream coming from the first and second multiplexing modules to the transmitted data cell stream.

2. The transmission system of claim 1, wherein the data cell transmission network is an ATM (Asynchronous Transfer Mode) network.

3. The transmission system of claim 1, wherein the first and second multiplexing modules have a same data transmission rate.

4. The transmission system of claim 1, wherein each of the first and second multiplexing modules includes a transmission interface for connection to one of the digital transmission lines, an input/output interface and a transfer interface, wherein the first and second multiplexing modules are so connectable in series that the transfer interface of one of the first and second multiplexing modules is connected to the input/output interface of the following one of the first and second multiplexing modules, wherein the unit for control and synchronization of the partial data cell streams taps a partial data cell stream from the data cell stream to be transmitted for transmission to one of the multiplexing modules and taps a further partial data cell stream from the remainder of the data cell stream for transmitting to the following multiplexing modules.

5. The transmission system of claim 1, wherein the first multiplexing module includes the unit for control and synchronization of the partial data cell streams.

6. The transmission system of claim 4, wherein the input/output interface and the transfer interface has a transmission rate of 25.6 MBit/s.

7. A method of transmitting a data cell stream between a central location, connected to a data cell transmission network, and a peripheral user-network termination unit, connected to the central location, via a plurality of digital transmission lines at a data transmission rate which is smaller than a data transmission rate of the transmission network, comprising the steps of:
dividing the data cell stream into several partial data cell streams in an inverse multiplexing device of one of the central location and the user-network termination unit,
transmitting the partial data cell stream to an inverse multiplexing device of the other one of the central location and the user-network termination unit via the digital transmission lines, with the inverse multiplexing device of the peripheral user-network termination unit including a first multiplexing module and at least one second multiplexing module, with the first and second multiplexing modules associated to the transmission lines in one-to-one correspondence, whereby the data cell stream to be transmitted is divided according to the number of multiplexing modules and their transmission rate into partial data cell streams, wherein the partial data cell streams are fed to the multiplexing modules or the partial data cell streams coming from the multiplexing modules are added to the data cell stream being transmitted, and
combining the partial data cell streams in the inverse multiplexing device of the other one of the central location and user-network termination unit.

8. The method of claim 7, wherein the data cell transmission network is an ATM (Asynchronous Transfer Mode) network.

9. A data transmission method between an inverse multiplexing device of a central location and an inverse multiplexing device of a peripheral user-network termination unit, comprising the steps of:
dividing a data stream into several data cells in one of the inverse multiplexing devices of the central location and the peripheral user-network termination unit;
transmitting the data cells to the inverse multiplexing device of the other one of the central location and the peripheral user-network termination unit in dependence on the number of multiplexing modules contained in the inverse multiplexing device of the peripheral user-network termination unit so as to provide a sequential data transmission to the inverse multiplexing device of the other one of the central location and the peripheral user-network termination unit; and
combining the data cells in the inverse multiplexing device of the other one of the central location and user-network termination unit.
